(19) United States
(12) Patent Application Publication
(10) Pub. No.: US 2019/0138730 A1
(43) Pub. Date: May 9, 2019

(54) System and Method to Support Boot Guard for Original Development Manufacturer BIOS Development

(71) Applicant: DELL PRODUCTS, LP, Round Rock, TX (US)

(72) Inventors: Wei Liu, Austin, TX (US); Juan F. Diaz, Round Rock, TX (US); Vyacheslav V. Kowal, Round Rock, TX (US); William A. Moyes, Austin, TX (US); Vaden A. Mohrmann, Cedar Park, TX (US)

(21) Appl. No.: 15/803,128

(22) Filed: Nov. 3, 2017

(51) Int. Cl. G06F 21/57; H04L 9/32

(52) U.S. Cl. CPC G06F 21/575; H04L 9/3236; H04L 9/3263

(57) ABSTRACT

An information handling system authenticates a key manifest of a memory with a hash of a key associated with the key manifest. When the key manifest is authentic, the system authenticates a boot policy manifest with the hash of first public key associated with the boot policy manifest. When the boot policy manifest is authentic, the system validates a pre-boot block of the memory based upon the hash of the pre-boot block stored in the boot policy manifest and directs a processor to execute the pre-boot code when the pre-boot block is valid. A processor executes the pre-boot code to execute a reset vector and to determine if the boot block is valid with hash of the boot block, and executes the boot code when the boot block is valid.

### FIELD OF THE DISCLOSURE

This disclosure generally relates to information handling systems, and more particularly relates to boot guard for BIOS development.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may authenticate a key manifest of a memory with a hash of a key associated with the key manifest. If the key manifest is authentic, the system may authenticate a boot policy manifest with the hash of first public key associated with the key manifest. If the boot policy manifest is authentic, the system may validate a pre-boot block of the memory based upon the hash of the pre-boot block and direct a processor to execute the pre-boot code when the pre-boot block is valid. The pre-boot code may execute a reset vector and determine if the boot block is valid with hash of the boot block, and execute the boot code when the boot block is valid.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a generalized information handling system according to an embodiment of the present disclosure;

FIG. 2 is a block diagram illustrating an information handling system according to an embodiment of the present disclosure;

FIG. 3 is a block diagram of BIOS code elements to execute a trusted boot process on the information handling system of FIG. 2; and

FIG. 4 is a flowchart illustrating a method of executing an initial boot block in a trusted boot process according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

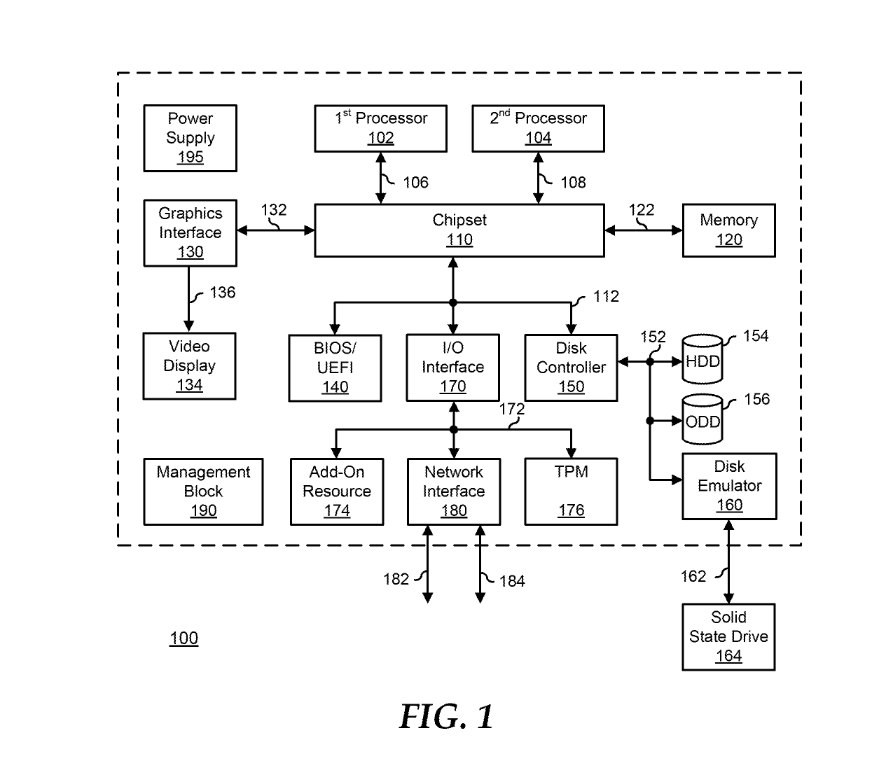

FIG. 1 illustrates a generalized embodiment of an information handling system 100. For purpose of this disclosure information handling system 100 can be configured to provide the features and to perform the functions of the OPF system as described herein. Information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described below, and operates to perform one or more of the methods described below. Information handling system 100 includes a processors 102 and 104, a chipset 110, a memory 120, a graphics interface 130, a basic input and output system/universal extensible firmware interface (BIOS/UEFI) module 140, a disk controller 150, a hard disk drive (HDD) 154, an optical disk drive (ODD) 156, a disk emulator 160 connected to an external solid state drive (SSD) 162, an input/output (I/O) interface 170, one or more add-on resources 174, a trusted platform module (TPM) 176, a network interface 180, a management block 190, and a power supply 195. Processors 102 and 104, chipset 110, memory 120, graphics interface 130, BIOS/UEFI module 140, disk controller 150, HDD 154, ODD 156, disk emulator 160, SSD 162, I/O interface 170, add-on resources 174, TPM 176, and network interface 180 operate together to provide a host environment of information handling system 100 that operates to provide the data processing functionality of the information handling system. The host environment operates to execute machine-executable code, including platform BIOS/UEFI code, device firmware, operating system code, applications, programs, and the like, to perform the data processing tasks associated with information handling system 100.

In the host environment, processor 102 is connected to chipset 110 via processor interface 106, and processor 104 is connected to the chipset via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/UEFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 140 includes BIOS/UEFI code operable to detect resources within information handling system 100, to provide drivers for the resources, initialize the resources, and access the resources. BIOS/UEFI module 140 includes code that operates to detect resources within information handling system 100, to provide drivers for the resources, to initialize the resources, and to access the resources.

Disk controller 150 includes a disk interface 152 that connects the disk controller to HDD 154, to ODD 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an IEEE 1394 (Firewire) interface, a proprietary interface, or a combination thereof. Alternatively, solid-state drive 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

Management block 190 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 100. In particular, management block 190 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 100, such as system cooling fans and power supplies. Management block 190 can include a network connection to an external management system, and the management block can communicate with the management system to report status information for information handling system 100, to receive BIOS/UEFI or system firmware updates, or to perform other task for managing and controlling the operation of information handling system 100. Management block 190 can operate off of a separate power plane from the components of the host environment so that the management block receives power to manage information handling system 100 when the information handling system is otherwise shut down. An example of management block 190 may include a commercially available BMC product that operates in accordance with an Intelligent Platform Management Initiative (IPMI) specification, such as a Integrated Dell Remote Access Controller (iDRAC), or the like. Management block 190 may further include associated memory devices, logic devices, security devices, or the like, as needed or desired.

Power supply 195 represents one or more devices for power distribution to the components of information handling system 100. In particular, power supply 195 can include a main power supply that receives power from an input power source, such as a wall power outlet, a power strip, a battery, or another power source, as needed or desired. Here, power source 195 operates to convert the power at a first voltage level from the input power source to one or more power rails that are utilized by the components of information handling system. Power supply 195 can also include one or more voltage regulators (VRs) that each receive power from the main power supply and that operate to convert the input voltage to an output voltage that is used by one or more components of information handling system. For example, a VR can be provided for each of processors 102 and 104, and another VR can be provided for memory 120. Power supply 195 can be configured to provide a first power plane that provides power to the host environment, and to provide a second power plane that provides power to the management environment.

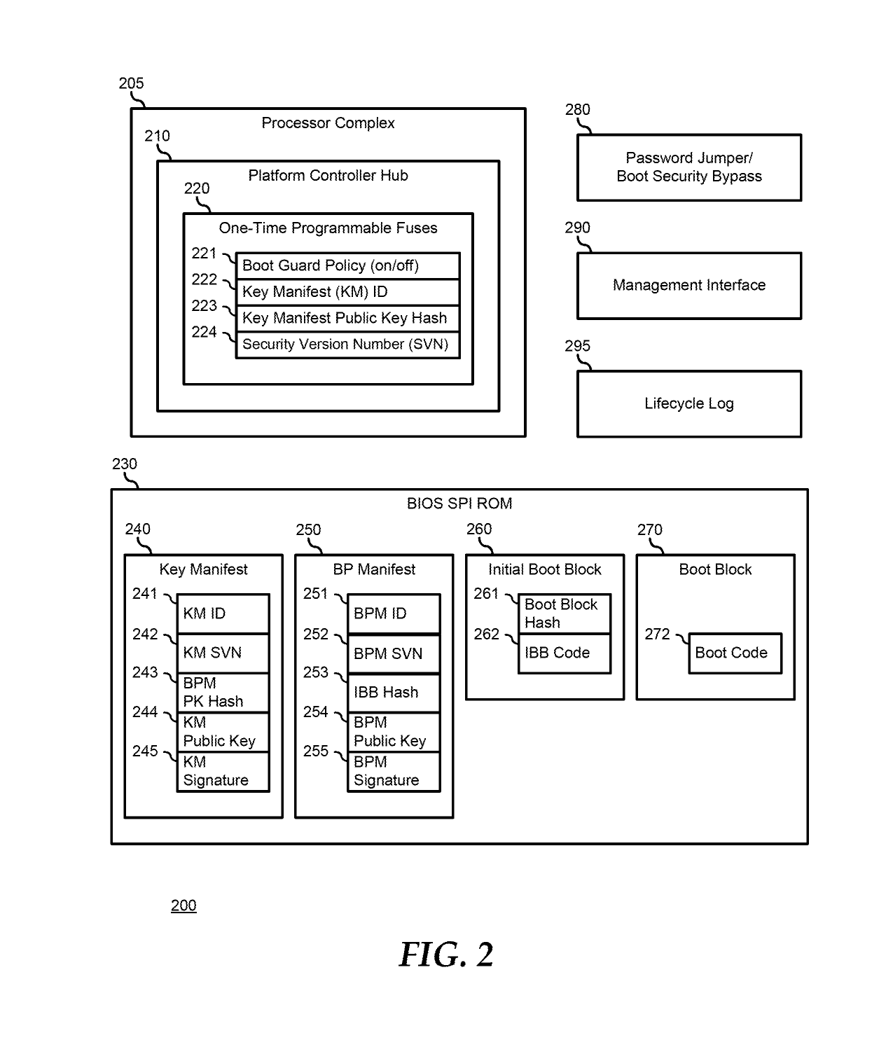

FIG. 2 illustrates an information handling system 200 similar to information handling system 100, and including a processor complex 205, a Basic Input/Output System (BIOS) Serial Peripheral Interface (SPI) read-only memory (ROM) 230, a password/boot security bypass jumper 280, hereinafter referred to as bypass jumper 280, and a management interface 290, and a Lifecycle log 295. Processor complex 205 operates to provide data processing functionality of information handling system 200, such as is typically associated with an information handling system. As such, processor complex 205 represents a data processing apparatus, such as one or more central processing units (CPUs) or processor cores, and the associated data input and output I/O functionality, such as a chipset component, and other I/O processor components. Processor complex 205 operates to execute machine-executable code to perform the data processing tasks associated with information handling system 200.

Processor complex 205 includes a platform controller hub (PCH) 210. PCH 210 represents a chipset component of information handling system 200 that manages and controls various data paths between processor complex 205 and other elements of the information handling system. It will be understood that PCH 210 is provided as an exemplary architectural implementation of information handling system 200, but that such an implementation is not intended to limit the scope of the present disclosure. In particular, processor complex 205 and PCH 210 may be implemented as separate elements of information handling system 200, or may be integrated as a single system-on-a-chip (SoC), as needed or desired. The functions and features of a PCH are known in the art and will not be further disclosed herein, except as needed to illustrate the various embodiments disclosed herein.

PCH 210 operates to implement a trusted boot process that ensures that the root of trust for all software operations is held by the PCH. An example of a trusted boot process includes platform components from Intel Corporation that employ Intel Platform Protection Technology with Boot Guard, platform components from Advanced Micro Devices, Inc. that employ AMD Secure Technology, or other platform components that employ a hardware based root of trust, as needed or desired. As described herein, the functions and features of the present disclosure will utilize Intel Boot Guard as an exemplary architectural implementation, but this is not necessarily so, and other architectural implementations may be utilized as needed or desired.

PCH 210 includes one-time programmable (OTP) fuses 220, including a Boot Guard policy fuse 221, a key manifest (KM) identification fuse 222, a key manifest public key hash fuse 223, and a security version number (SVN) fuse 224. It will be understood that each of fuses 221, 222, 223, and 224 represent multiple fusible links or other one-time programmable bit locations that are programmed, or fused, with the associated information, and, after programming, that operate as read-only memory locations of PCH 210. It will also be understood that each of fuses 221, 222, 223, and 224 may represent multiple sets of fuses, such that, after an initial set of fuses is programmed, that set of fuses is operative, but that, when a subsequent set of fuses is programmed, the subsequent set of fuses becomes operative, and the initial set is ignored.

Boot Guard policy fuse 221 operates as a setting to enable the trusted boot process on information handling system 200. As such, before Boot Guard policy fuse 221 is programmed, information handling system 200 does not operate according to the trusted boot process, but is protected by the trusted boot process after the Boot Guard policy fuse is programmed. Key manifest identification fuse 222 is programmed to identify a key manifest 240 in BIOS ROM 230 that forms the first software link in the trusted boot process, as described further, below. Key manifest public key hash fuse 223 is programmed with a hash of a public key associated with key manifest 240 that is utilized in authenticating that the key manifest is valid and untampered with. SVN fuse 224 is programmed with version information related to the particular key manifest version of key manifest 240 that is programmed into key manifest identification 222, and to the hash information of the public key of the key manifest that is programmed into key manifest public key hash fuse 223. As such, where fuses 221, 222, 223, and 224 represent multiple sets of fuses, SVN fuse 224 operates to identify a version associated with the particular set of fuses that is operative at a particular time.

BIOS ROM 230 includes key manifest 240, a boot policy (BP) manifest 250, an initial boot block (IBB) 260, also referred to as a pre-boot block, and a boot block 270. Key manifest 240 includes a key manifest identification 241, a key manifest SVN 242, a BP manifest public key hash 243, a key manifest public key 244, and a key manifest digital signature 245. BP manifest 250 includes a BP identification 251, a BP SVN 252, an IBB hash 253, a BP manifest public key 254, and a BP manifest digital signature 255. IBB 260 includes boot block hash 261 and IBB code 262. Boot manifest 270 includes boot code 272.

Key manifest identification 241 corresponds with the information in key manifest identification fuse 222, such that, if the information in key manifest identification 241 differs from the information programmed into key manifest identification fuse 222, then the system boot process is halted. Similarly, BP manifest identification 251 represent information that identifies BP manifest 250. Key manifest SVN 242 includes version information related to the particular version of key manifest 240. Similarly, BP manifest SVN 252 includes information related to the particular version of BP manifest 250. Public keys 244 and 254, in conjunction with respective digital signatures 245 and 255, each operate to authenticate respective manifests 240 and 250 to ensure that the manifests are valid and untampered with.

Key manifest public key 244 represents a public key portion of a public/private key pair that is generated, maintained, and authenticated based upon an authentication authority associated with the manufacturer of information handling system 200, and for which the associated private key is closely held by the manufacturer. Here, key manifest public key 244 is utilized in conjunction with key manifest digital signature 245 to authenticate to PCH 210 that key manifest 240 is valid and untampered with. In this way, the hardware portions of information handling system 200, that is, PCH 210 and BIOS ROM 230, maintain a hardware root of trust for the subsequent activities performed on the information handling system. Here, if key manifest 240 is successfully authenticated by PCH 210, then the PCH will trust the key manifest and use it to further authenticate BP manifest 250.

Once key manifest 240 passed authentication, PCH authentication code, also referred to as the Authentication Code Module (ACM), operates to authenticate BP manifest 250. Here, BP manifest public key 254 represents a public key portion of another public/private key pair that is utilized in conjunction with BP manifest digital signature 255 to authenticate to the PCH authentication code that BP manifest 250 is valid and untampered with. Here, if BP manifest 250 is successfully authenticated, the PCH authentication code proceeds to validate IBB 260 using IBB hash 253.

Once the PCH authentication code assumes control of information handling system 200, the PCH authentication code operates to validate IBB 260. Here, IBB hash 253 represents a predetermined hash of the contents of IBB 260. In validating IBB 260, the PCH authentication code calculates a hash of the IBB, and compares the calculated hash with IBB hash 253 to determine if the IBB is valid and untampered with. If the calculated hash of IBB 260 matches IBB hash 253, then BP manifest 250 passes control of information handling system 200 to the IBB. However, if the calculated hash of IBB 260 does not match IBB hash 253, then BP manifest 250 halts further processing on information handling system 200.

Once IBB 260 assumes control of information handling system 200, the IBB operates to execute IBB code 262 to run a portion of the functions and features of a platform boot process, as are known in the art, on information handling system 200, and to validate boot block 270. The portion of the functions and features of the platform boot process will be described further below. Here, boot block hash 261 represents a predetermined hash of the contents of boot block 270. In validating boot block 270, IBB 260 calculates a hash of the boot block, and compares the calculated hash with boot block hash 261 to determine if the boot block is valid and untampered with. If the calculated hash of boot block 270 matches boot block hash 261, then IBB 260 passes control of information handling system 200 to the boot block. However, if the calculated hash of boot block 260 does not match boot block hash 261, then IBB 260 halts further processing on information handling system 200. It will be understood that the details of authentication of digital signatures, the use of public/private key pairs, the hashing functions for hashing the public keys, and other authentication activities will be readily understood to the person skill in the art. In particular, the utilization of a Public Key Infrastructure is known in the art. As such, such details will not be further discussed herein, except as needed to describe the present embodiments.

Once boot block 270 assumes control of information handling system 200, the boot block operates to execute boot code 272 to run the remainder of the functions and features of the platform boot process. Here, upon the successful authentication of key manifest 240 and BP manifest 250, and the successful validation of IBB 260 and boot block 270, the root of trust is established and extended to the platform BIOS level. After this point, the extension of the root of trust to the operating environment of information handling system 200 may be performed to ensure the security of the operating system and application programs running on the information handling system. The extension of the root of trust to the operating environment of an information handling system is known in the art and will not be further discussed herein, except as needed to illustrate the present embodiments.

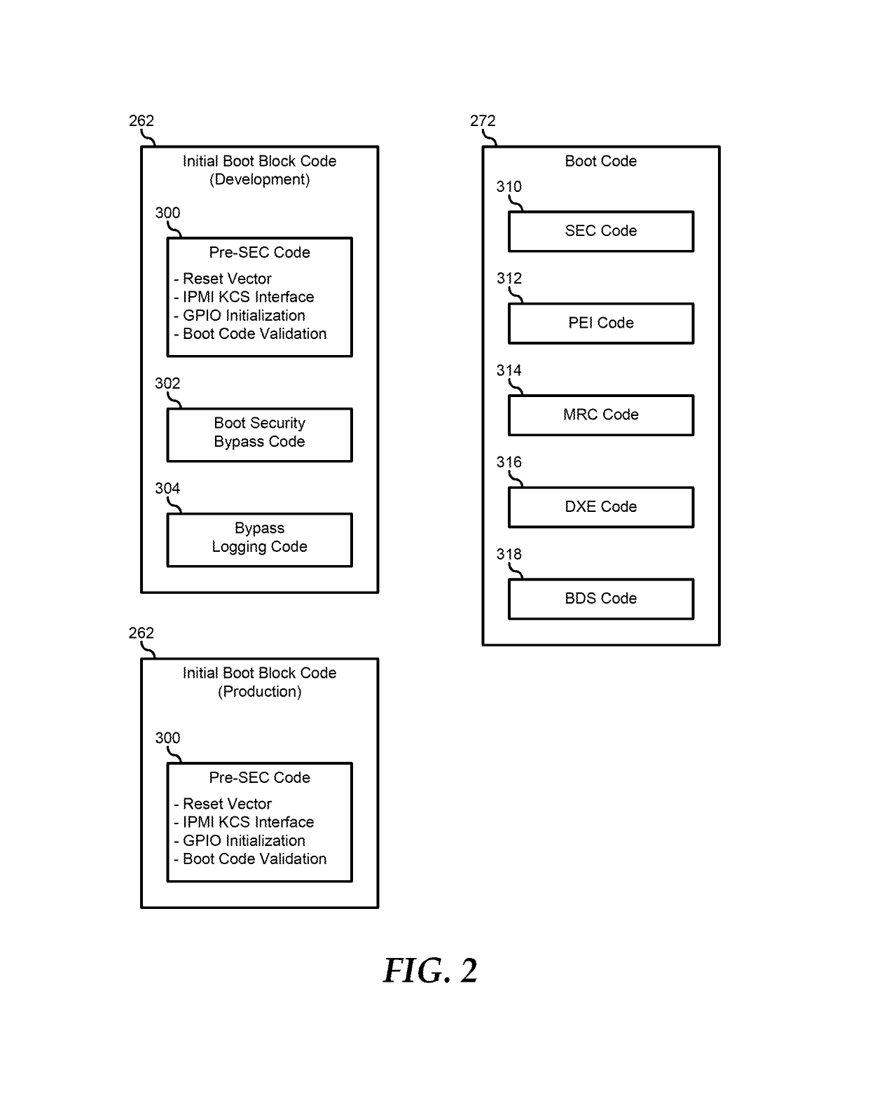

FIG. 3 illustrates IBB code 262 and boot code 272. IBB code 262 is illustrated in a development BIOS version and in a production BIOS version. Development IBB code 262 includes a pre-security (Pre-SEC) code portion 300, a boot security bypass code portion 302, and a bypass logging code portion 304. Production IBB code 262 only includes Pre-SEC code portion 300. Pre-SEC code portion 300 includes code to run a small portion of the early functions and features of the platform boot process, including a CPU reset vector, code for initiating an Intelligent Platform Management Interface (IPMI) keyboard controller style (KCS) interface, code for initializing one or more general purpose I/Os (GPIOs) of information handling system 200, and code for validating boot block 270. For the purpose of BIOS development for information handling system 200, the intent of pre-SEC code portion 300 is to provide a secure, tamper-resistant, validated module of the functions and features of the platform boot process that are relatively stable and unchanging during the course of development. In this way, validation of pre-SEC code portion 300 can be performed one time, early in the BIOS development process, and the hash of IBB 260 can be calculated and inserted into IBB hash 253 to provide a root of trust to the IBB. As a result, subsequent development BIOS versions of boot block 270 can be implemented by BIOS developers without the need to invoke the manufacture's keying infrastructure each time a new version is propagated.

Bypass jumper 280 operates on a production system to permit a user to bypass a system password in the platform BIOS of information handling system. For example, a system administrator may install, remove, or change a location of a jumper on a set of jumper pins on a system printed circuit board of information handling system 200 to permit the information handling system to be booted without a password authentication process. In a particular embodiment, during the development of information handling system 200, for example, when development IBB code 262 is installed in the information handling system, bypass jumper 280 operates to suspend the validation of boot block 270. In this way, development BIOS versions of boot block 270 may be propagated without the need to perform the hash calculation on the boot block, and the associated modification of IBB 260 by the addition of a revised IBB hash 253. In operation, when IBB 270 has assumed control of information handling system 200, the IBB executes pre-SEC code portion 300, but prior to performing the boot code validation portion of the pre-SEC code portion, the IBB executes boot security bypass code portion 302 to determine the setting of bypass jumper 280. If bypass jumper 280 is in a first, secure, setting, IBB 270 executes the boot code validation portion of pre-SEC code portion 300, and execution proceeds based upon whether or not boot block 270 is determined to be valid, as described above. On the other hand, if bypass jumper 280 is in a second, bypass, setting, IBB 270 passes control of information handling system 200 directly to boot block 270 without validating the boot block.

Management interface 290 and Lifecycle log 295 represent portions of a platform management subsystem of information handling system 200, such as an embedded controller, a Baseboard Management Controller (BMC), an Integrated Dell Remote Access Controller (iDRAC), or another platform management system. In particular, management interface 290 represents a network interface device, such as a network interface controller (NIC), a LAN-on-motherboard (LOM), a host bus adapter (HBA), or another network interface device that is coupled to a management network for out-of-band (00B) management of information handling system 200. Lifecycle log 295 represents an error, status, and management log for the platform management subsystem that provides for logging of various events, status information, or other information by the platform management subsystem, as needed or desired. When bypass jumper 280 is in the second, bypass, setting, IBB 270 executes bypass logging code portion 304 to send an alert to a management system via management interface 290 that the secure boot process for information handling system 200 has been bypassed, and to log the fact that the secure boot process has been bypassed in Lifecycle log 295. In another embodiment, in addition to adding logs, IBB 270 toggles a hardware general purpose I/O (GPIO) that provides additional indications, such as a flashing LED indicator or the like.

Boot code 272 includes a security (SEC) code portion 310 of the UEFI, a Pre-EFI Initialization (PEI) code portion 312 of the UEFI, a memory reference code (MRC) portion 314 of the UEFI, a Driver Execution Environment (DXE) code portion 316 of the UEFI, and a Boot Device Select (BDS) code portion 318 of the UEFI. In a particular embodiment, the functions and features of the platform boot process are further segregated into subsequent boot process blocks that are each validated by the preceding boot process block. For example, boot code 272 may include PEI code, MRC, a hash function to determine a hash of a subsequent boot process block, a predetermined hash of the subsequent boot process block, and code to compare the hash of the subsequent boot process block and the predetermined hash of the subsequent boot process block. Similarly, the subsequent boot process block can include a remainder of the functions and features of the platform boot process, such as DXE code, and BDS code, or other code. Other subsequent boot process blocks may be further segregated, as needed or desired.

Information handling system 200 differs from a typical information handling system in that BIOS ROM 230 includes boot block 270 and the chain of trust extends to the boot block, while the typical information handling system that implements a Boot Guard architecture only extends the chain of trust to an IBB. Further, in the present embodiment, the functions and features of a system boot process that are included in IBB 260 are limited, and the larger portion of the phases of the boot process, namely, the PEI phase, the MRC phase, the DXE phase, and the BDS phase are included in boot block 270. In contrast, in the typical information handling system, these phases are performed by the IBB.

The present embodiments provide benefits to the platform development process, and also provide benefits when a platform BIOS is updated. As noted above, in the present embodiments, a BIOS developer does not need to invoke the manufacturer's authentication authority each time a new BIOS revision is executed, because, with bypass jumper 280 set in the bypass setting, the BIOS developer can freely modify the BIOS code as needed to develop a robust platform BIOS. On the other hand, if bypass jumper 280 is set in the secure setting, the BIOS developer only needs to replace boot block hash 261 in order to maintain the chain of trust for the development versions of the platform BIOS. Further, once information handling system 200 is fully developed, a manufacturer need only replace development IBB code 262 with production IBB code 262, calculate a hash of IBB 260, replace IBB hash 253 in BP manifest 250, and generate a new BP manifest digital signature 255.

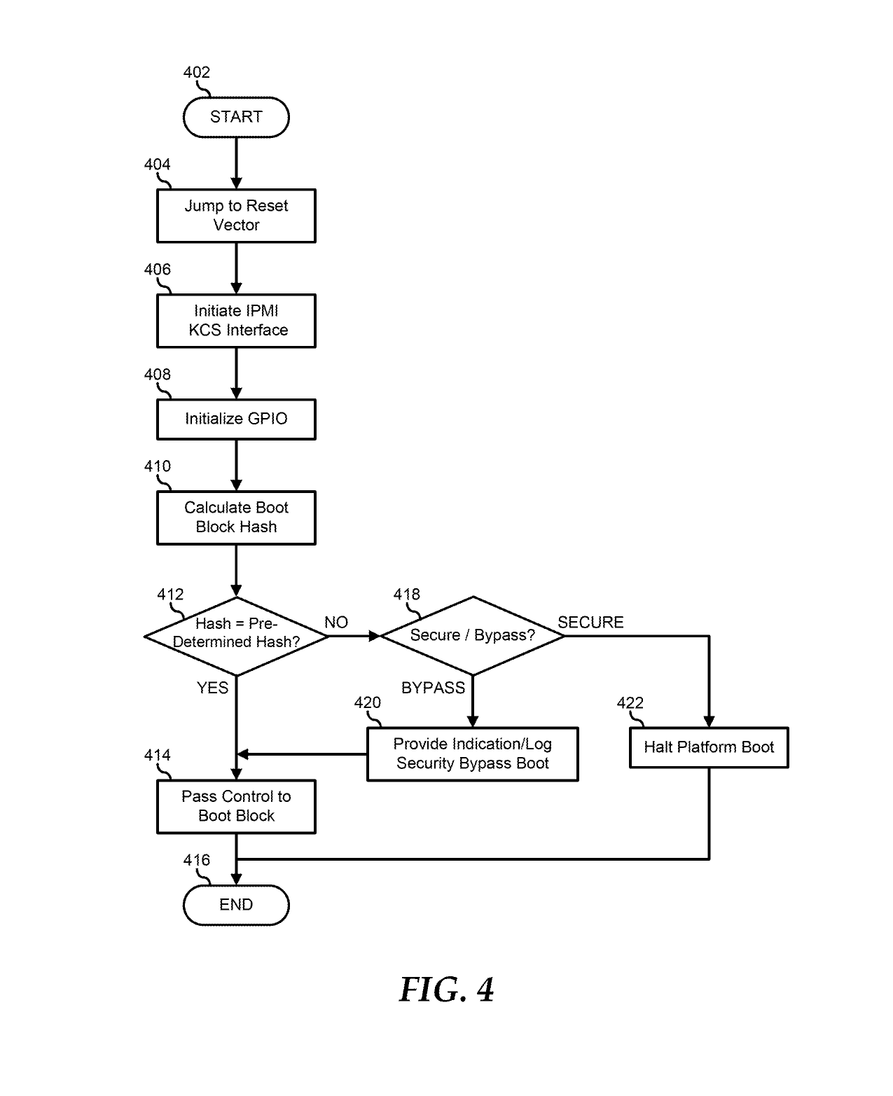

FIG. 4 illustrates a method of executing an initial boot block (IBB) in a trusted boot process starting at block 402. IBB code of the IBB is executed to jump code reads to a reset vector in block 404. For example, information handling system 200 may have established a chain of trust to IBB 260, and started to execute IBB code 261 to execute the reset vector. The IBB code is executed to initiate an IPMI KCS interface of the information handling system in block 406. For example, IBB code 261 can be executed to initiate the IPMI KCS interface on information handling system 200. The IBB code is executed to initialize one or more GPIO of the information handling system in block 408. For example, IBB code 261 can be executed to initiate one or more GPIO of information handling system 200. The IBB code is executed to calculate a hash of a boot block of the information handling system in block 410. For example, IBB code 261 can be executed to calculate a hash of boot block 270.

The IBB code is executed to make a decision as to whether or not the calculated hash of the boot block matches a pre-determined hash of the boot block to validate that the boot block is secure and untampered with in decision block 412. For example, IBB code 261 can compare the calculated hash of boot block 270 with the pre-determined boot block hash 262 to validate that the boot block is secure and untampered with. If the calculated hash of the boot block matches the pre-determined hash of the boot block, the “YES” branch of decision block 412 is taken, the IBB code is executed to pass control of the information handling system to the boot block in block 414, and the method ends in block 416. If the calculated hash of the boot block does not match the pre-determined hash of the boot block, the “NO” branch of decision block 412 is taken, the IBB code is executed to make a decision as to whether or not a bypass jumper is in a secure setting or in a bypass setting in decision block 418. For example, IBB code 261 can determine whether bypass setting 280 is in a secure setting or in a bypass setting.

If the bypass jumper is in the bypass setting, the “BYPASS” branch of decision block 418 is taken, the IBB code is executed to provide an indication and log that the boot was conducted under the bypass setting in block 420, and the method proceeds to block 414 where the IBB code is executed to pass control of the information handling system. If the bypass jumper is in the secure setting, the “SECURE” branch of decision block 418 is taken, the platform boot process is halted in block 422, and the method ends in block 416.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a processor;
a memory device configured to store code including:
a boot block including boot code;
a pre-boot block including a hash of the boot block and pre-boot code;
a boot policy manifest including a first public key and a hash of the pre-boot block; and
a key manifest including a second public key and a hash of a first public key; and
a controller including a hash of a second public key, the controller configured to:
authenticate that the key manifest is valid based upon the hash of the second public key;
authenticate that the boot policy manifest is valid based upon the hash of the first public key;
validate the pre-boot block based upon the hash of the pre-boot block included in the authenticated boot policy manifest; and
direct the processor to execute the pre-boot code in response to validating the pre-boot block;
wherein the processor is configured to:
execute the pre-boot code to execute a reset vector and to determine whether the boot block is valid based upon the hash of the boot block; and
execute the boot code in response to determining that the boot block is valid.

2. The information handling system of claim 1, further comprising:
a bypass setting configurable in one of a secure mode and a bypass mode, wherein the processor is further configured to determine whether the bypass setting is in the secure mode or in the bypass mode in response to determining that the boot block is not valid.

3. The information handling system of claim 2, wherein the processor if further configured to halt the boot process in response to determining that the bypass setting is in the secure mode.

4. The information handling system of claim 2, wherein the processor if further configured to execute the boot code in response to determining that the bypass setting is in the bypass mode.

5. The information handling system of claim 4, further comprising:
a management interface, wherein the processor is further configured to provide an indication that the boot code is being executed to the management interface in further response to determining that the bypass setting is in the bypass mode.

6. The information handling system of claim 4, further comprising:
a log, wherein the processor is further configured to provide a log entry indication that the boot code is being executed to the log in further response to determining that the bypass setting is in the bypass mode.

7. The information handling system of claim 1, wherein the processor is further configured, prior to validating the boot block, to initialize a keyboard controller style (KCS) interface and to initialize a general purpose input/output (GPIO).

8. The information handling system of claim 1, wherein the boot code includes Universal Extensible Firmware Interface (UEFI) security phase code, UEFI Pre-EFI Initialization phase code, memory reference code, UEFI Driver Execution Environment phase code, and UEFI Boot Device Select phase code.

9. A method, comprising:
authenticating, by a controller of an information handling system, that a key manifest stored on a memory device of the information handling system is valid based upon a hash of a first public key associated with the key manifest, the hash of the first public key stored in the controller;
authenticating, by the controller, that a boot policy manifest stored on the memory device is valid based upon a hash of a second public key associated with the boot policy manifest, the hash of the second public key included in the key manifest;
validating, by the controller, a pre-boot block stored on the memory device based upon a hash of the pre-boot block, the hash of the pre-boot block included in the boot policy manifest;
directing, by the controller, a processor of the information handling system to execute the pre-boot code in response to validating the pre-boot block;
executing, by the processor, the pre-boot code to execute a reset vector and to determine whether the boot block is valid based upon a hash of the boot block, the hash of the boot block included in the pre-boot block; and
executing, by the processor, the boot code in response to determining that the boot block is valid.

10. The method of claim 9, further comprising:
determining, by the processor, whether a bypass setting of the information handling system is in a secure mode or in a bypass mode in response to determining that the boot block is not valid.

11. The method of claim 10, further comprising:
halting, by the processor, the boot process in response to determining that the bypass setting is in the secure mode.

12. The method of claim 10, further comprising:
executing, by the processor, the boot code in response to determining that the bypass setting is in the bypass mode.

13. The method of claim 12, further comprising:
providing, by the processor, an indication that the boot code is being executed to a management interface of the information handling system in further response to determining that the bypass setting is in the bypass mode.

14. The method of claim 12, further comprising:
providing, by the processor, a log entry indication that the boot code is being executed to a log of the information handling system in further response to determining that the bypass setting is in the bypass mode.

15. The method of claim 9, wherein prior to validating the boot block, the method further comprises:
initializing, by the processor; a keyboard controller style (KCS) interface; and
initializing, by the processor, a general purpose input/output (GPIO).

16. The method of claim 9, wherein the boot code includes Universal Extensible Firmware Interface (UEFI) security phase code, UEFI Pre-EFI Initialization phase code, memory reference code, UEFI Driver Execution Environment phase code, and UEFI Boot Device Select phase code.

17. An information handling system, comprising:
a memory device configured to store code including:
a boot block including boot code; and
a pre-boot block including a hash of the boot block and pre-boot code; and
a controller configured to:
validate the pre-boot; and
direct a processor to execute the pre-boot code in response to validating the pre-boot block;
wherein the processor is configured to:
execute the pre-boot code to execute a reset vector and to determine whether the boot block is valid based upon the hash of the boot block; and
execute the boot code in response to determining that the boot block is valid.

18. The information handling system of claim 17, further comprising:
a bypass setting configurable in one of a secure mode and a bypass mode, wherein the processor is further configured to determine whether the bypass setting is in the secure mode or in the bypass mode in response to determining that the boot block is not valid.

19. The information handling system of claim 18, wherein the processor if further configured to halt the boot process in response to determining that the bypass setting is in the secure mode.

20. The information handling system of claim 18, wherein the processor if further configured to execute the boot code in response to determining that the bypass setting is in the bypass mode.
